(19) United States
(12) Patent Application Publication
(10) Pub. No.: US 2005/0201207 A1
(43) Pub. Date: Sep. 15, 2005

(54) Wall and/or table clock designed for indicating the hours of all the countries included in the time zones

(76) Inventor: Mohamed Ferid Belkhodja, Milano (IT)

Correspondence Address: HEDMAN & COSTIGAN P.C., 1185 AVENUE OF THE AMERICAS, NEW YORK, NY, 10036, US

(21) Appl. No.: 11/077,455

(22) Filed: Mar. 10, 2005

(30) Foreign Application Priority Data
Mar. 11, 2004 (IT) MI2004U000099

(51) Int. Cl. G04B 19/22

(52) U.S. Cl. 368/27

(57) ABSTRACT

The present invention relates to a wall and/or table clock designed for indicating the hours of all the countries included in the time zones, which comprises an outer clock dial with the indications of all the time zones and the towns corresponding to the related time zones. The outer clock dial defines a reference or sight annular zone on the top part of which is arranged a fixed reference arrow. Under the outer clock dial an inner clock dial is provided, having marks for indicating the 0 to 24 hours which can be indicated by the annular or ring zone. The inner clock dial is coupled to motor means for providing a full revolution each 24 hours.

### BACKGROUND OF THE INVENTION

The present invention relates to a wall and/or table clock, designed for indicating the hours of all the countries included in the time zones.

As is known, a very important problem is that of timely detect the hours of the several countries through the world.

In fact, the increasing diffusion of interexchanges, both of commercial and private nature, requires to immediately know the hours through the different zones of the world.

Prior solutions for solving the above mentioned problem, on the other hand, have not been found to fully solve said problem, since they do not provide a clock which can be easily and immediately read-out.

Thus, great difficulties are encountered in this field.

### SUMMARY OF THE INVENTION

Accordingly, the aim of the present invention is to overcome the above mentioned drawbacks, by providing a wall and/or table clock designed for indicating the hours of all the countries included in world time zones, which is adapted to indicate, in an immediate manner, hours through the different countries of the world.

Within the scope of the above mentioned aim, a main object of the present invention is to provide such a clock which also allows to detect the arrangement of the sun on the reproduced hemisphere continents, i.e. both boreal and austral continents.

Another object of the present invention is to provide such a wall and/or table clock which, owing to its specifically designed features, is very reliable and safe in operation.

Yet another object of the present invention is to provide such a wall and/or table clock, designed for indicating the hours of all the countries of the different time zones, which can be easily made and which, moreover, is very competitive from a mere economic standpoint.

According to one aspect of the present invention, the above mentioned aim and objects, as well as yet other objects, which will become more apparent hereinafter, are achieved by a wall and/or table clock designed for indicating the hours of all the countries included in the time zones, characterized in that said clock comprises an outer clock dial, with an indication of all the time zones and towns corresponding to said time zones, said outer clock dial defining a reference annular zone, on a top of which is arranged a fixed reference arrow, under said outer clock dial being provided an inner clock dial with indications of the 0 to 24 hours which can be marked by said annular region, said inner clock dial being coupled to motor means performing a full revolution movement each 24 hours.

### BRIEF DESCRIPTION OF THE DRAWINGS

Further characteristics and advantages of the present invention will become more apparent hereinafter from the following detailed disclosure of a preferred, though not exclusive, embodiment of a wall and/or table clock, designed for indicating the hours of all countries included in the time zones, which is illustrated, by way of an indicative, but not limitative, example in the accompanying drawings, where:

FIG. 1 is a schematic front view illustrating the wall clock according to the present invention;

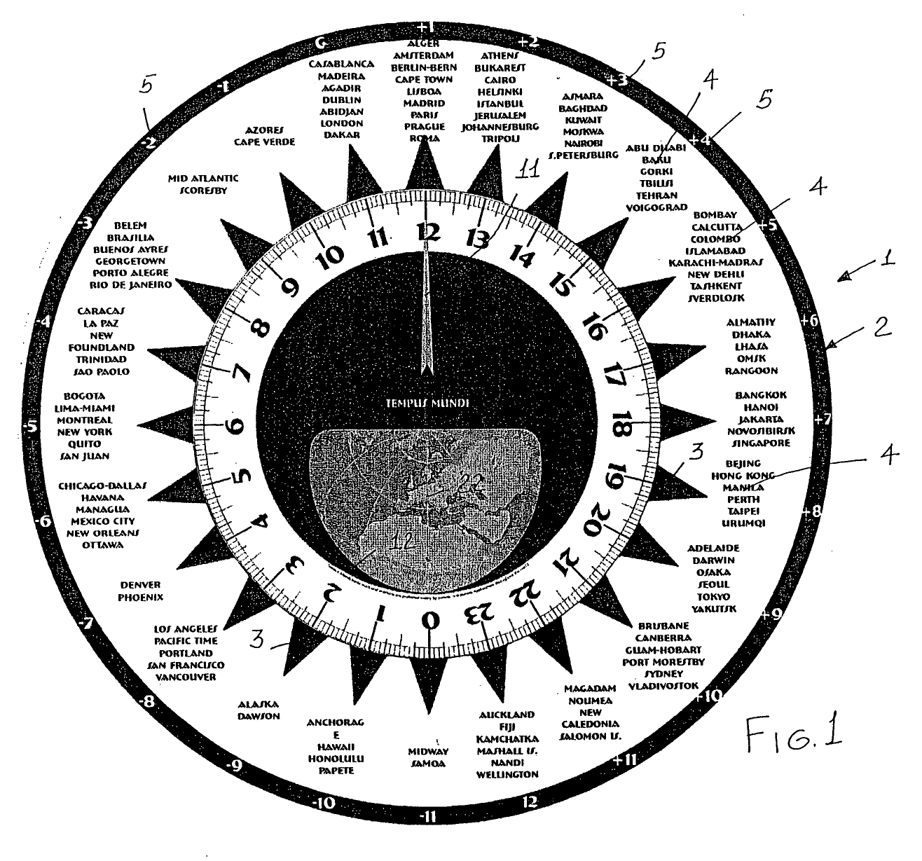

FIG. 2 is a further schematic view illustrating the inner rotary clock dial included in the wall clock according to the invention; and

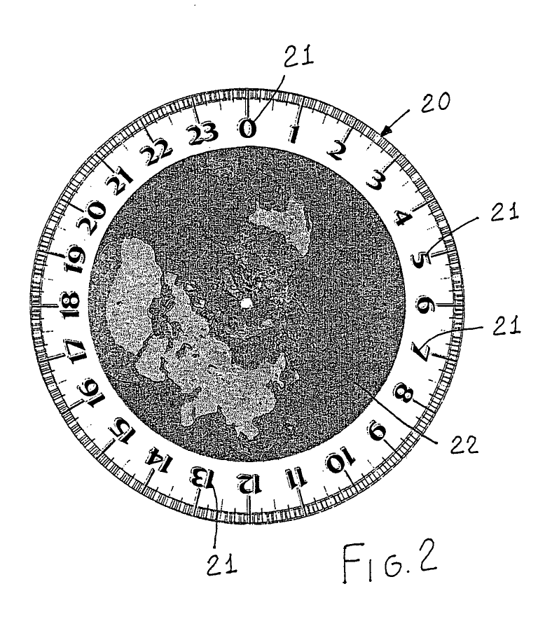

FIG. 3 illustrates a modified embodiment of the wall clock including a square clock dial.

### DESCRIPTION OF THE PREFERRED EMBODIMENT

With reference to the number references of the above mentioned figures, the wall and/or table clock, designed for indicating the hours of all countries included in the time zones, according to the present invention, which has been generally indicated by the reference number 1, comprises an outer clock dial 4, which comprises indicating marks for indications related to all the time zones, generally indicated by the reference number 3, at which are indicated the different world times, generally indicated by the reference number 4.

Moreover, the hours offset 5, either negative or positive with respect to the meridian O or prime meridian, is also indicated.

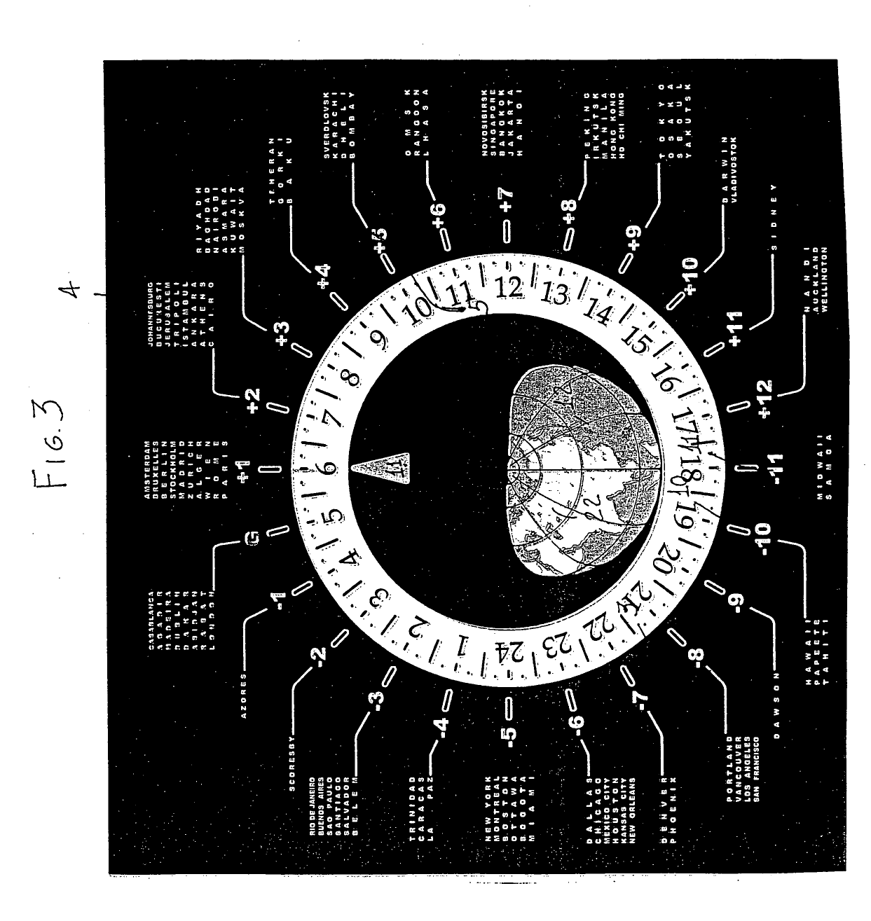

More specifically, the outer clock dial, which can have a circular configuration, as shown in figure, or a square configuration, as shown in FIG. 3, or any other desired configuration, defines an annular reference zone 10, on the top portion of which a fixed reference arrow, indicated by 11, is provided.

On the bottom portion of the central part, enclosed by the annular region 10, a transparent window 12 is provided, for displaying anything would be arranged under said window, as it will become more apparent hereinafter.

Under the outer clock dial 2, an inner clock dial 10 is provided, having indicating marks or indications 21 for indicating the 24 hours, which can be marked by the annular region.

Thus, the local hour will be arranged at the fixed reference arrow 11, whereas the other country hours will be arranged at the reference marks or indications 3 or other marks arranged at the several towns 4, with a related indication of the hour offset 5 with respect to the prime meridian.

On the central portion of the inner clock dial 20 a graphic representation 22 is shown for representing the austral hemisphere or boreal hemisphere, which can be easily seen through the window 12, with a corresponding indication of the world part which, at that given hour, is illuminated by the sun.

The inner clock dial 20 is coupled to motor means, provided for performing a full revolution each 24 hours, in an anticlockwise direction.

To provide a constant speed rotary or revolution movement while simultaneously exploiting the mechanical power on the drive axis, a synchronous electric motor with an associated speed reducing gear is used.

Thus, a synchronization of the movement on the electric signal frequency, will allow this motor to be used as a time base.

Moreover, a top light or lamp is arranged on the inner circular dial, at the fixed arrow 11 to properly illuminate the hour or hour fraction which can be seen under said reference arrow.

Moreover, a bottom lamp is further provided, for showing the position of the sun in the continents and seas, as the dial is synchronously rotated with the rotation of the hemisphere about the sun.

In the visible hemisphere portion, in which the sun shines, we will have a daylight condition, whereas in a night condition the continents will be dark and arranged under the black half circle, on the top portion of the outer dial 2.

The window 12 can further comprise a dashed band for indicating a passage from date to night, thereby detecting the hemisphere gloom zones, where light is growing or where the sun is setting.

It should be apparent that the clock assembly can be mounted on a metal, plastic, wood, glass or plastic material frame, thereby to be easily engaged on a wall or supported on a horizontal surface.

The configuration of the assembly can be square, rectangular or round, or any desired configurations.

The invention, as disclosed, is susceptible to several modifications and variations, all of which will come within the scope of the invention.

Moreover, all of the constructional details can be replaced by other technically equivalent elements.

In practicing the invention, the used materials, as well as the contingent size and shapes can be any, depending on requirements.

1. A wall and/or table clock designed for indicating the hours of all the countries included in the time zones, characterized in that said clock comprises an outer clock dial, with an indication of all the time zones and towns corresponding to said time zones, said outer clock dial defining a reference annular zone, on a top of which is arranged a fixed reference arrow, under said outer clock dial being provided an inner clock dial with indications of the 0 to 24 hours which can be marked by said annular region, said inner clock dial being coupled to motor means performing a full revolution movement each 24 hours.

2. A clock, according to claim 1, characterized in that said clock further comprises, at each town indication, a hour offset of a prime meridian.

3. A clock, according to claim 1, characterized in that said annular reference zone is substantially transparent.

4. A clock, according to claim 1, characterized in that said outer clock dial comprises, at a bottom part of a central portion delimited by said annular zone, a display window for displaying said inner clock dial.

5. A clock, according to claim 1, characterized in that said clock further comprises, on said inner clock dial, at a zone inside the hour indications, a graphic pattern for indicating a boreal hemisphere and an austral hemisphere.

6. A clock, according to claim 1, characterized in that said motor means comprise an electric synchronous motor with an associated speed reducing gear.

7. A clock, according to claim 1, characterized in that said clock further comprises a top lamp at said fixed reference arrow.

8. A clock, according to claim 1, characterized in that said clock further comprises a bottom lamp, arranged at said window.

9. A clock, according to claim 1, characterized in that said inner clock dial turns in an anticlockwise direction.
